(19) United States
(12) Patent Application Publication
(10) Pub. No.: US 2013/0201894 A1
(43) Pub. Date: Aug. 8, 2013

(54) METHODS AND APPARATUS FOR OPTIMIZING CELL BROADCAST SERVICE MESSAGE PROCESSING

(71) Applicant: Srinivasarao Pasumarthi, San Diego, CA (US)

(72) Inventor: Srinivasarao Pasumarthi, San Diego, CA (US)

(73) Assignee: Qualcomm Incorporated, San Diego, CA (US)

(21) Appl. No.: 13/453,684

(22) Filed: Apr. 23, 2012

Related U.S. Application Data
(60) Provisional application No. 61/593,966, filed on Feb. 2, 2012.

(51) Int. Cl. H04W 72/00; H04W 36/08

(52) U.S. Cl. CPC H04W 72/005; H04W 36/08
USPC 370/312

(57) ABSTRACT

A method and apparatus for optimizing a cell broadcast service (CBS) message decoding process is described. In an example, with a UE a CBS processing module may be configured to detect selection of a second cell by a user equipment (UE) being served by a first cell, determine whether the second cell and the first cell are within a common cell broadcast area, and maintain a message header associated with the first cell after the UE begins receiving service from the second cell upon a determination that the first cell and the second cell are within the common cell broadcast area. In another aspect, the CBS processing module may be configured to flush the message header associated with the first cell upon a determination that the first cell and the second cell are not within the common cell broadcast area.

### CLAIM OF PRIORITY UNDER 35 U.S.C. 119

The present application for patent claims priority to Provisional Application No. 61/593,966 entitled “OPTIMIZATION IN DECODING CBS MESSAGES” filed Feb. 2, 2012, and assigned to the assignee hereof and hereby expressly incorporated by reference herein.

### BACKGROUND

1. Field of the Invention

The present application relates generally to wireless communications, and more specifically to methods and systems for optimizing cell broadcast service (CBS) message decoding and/or processing.

2. Relevant Background

Wireless communication systems are widely deployed to provide various types of communication (e.g., voice, data, multimedia services, etc.) to multiple users. These systems may be multiple-access systems capable of supporting communication with multiple users by sharing the available system resources (e.g., bandwidth and transmit power). Examples of such multiple-access systems include Universal Mobile Telecommunications System (UMTS), code division multiple access (CDMA) systems, time division multiple access (TDMA) systems, frequency division multiple access (FDMA) systems, 3GPP Long Term Evolution (LTE) systems, and orthogonal frequency division multiple access (OFDMA) systems.

Generally, a CBS permits a number of unacknowledged general CBS messages to be broadcast to receivers (e.g., user equipment (UE)) within a particular region. CBS messages may be broadcast to defined geographical areas known as cell broadcast areas.

Currently, when a UE is registered on a first cell, the UE stores all unique message headers with a geographical scope (GS) assumed to be a cell wide GS. The UE uses the stored message headers for duplicate detection so as to avoid repetitions of same message. When the UE moves to a second cell, the UE flushes out all the stored unique message headers, and start storing unique message headers with GS again assumed to be a cell wide GS. If the UE returns to the first cell (e.g., in a ping-pong situation), the UE does not have any history of messages received during the previous registration on the first cell. As such, UE must try to again decode messages that were previously received. The current process results in inefficient duplicate message detection. Consequently, it would be desirable to have an efficient method and/or apparatus for decoding and/or processing CBS messages.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with one or more aspects and corresponding disclosure thereof, various aspects are described in connection with optimizing a CBS message decoding process. According to one aspect, a method for optimizing a CBS message decoding process is provided. The method may include detecting selection of a second cell by a UE being served by a first cell. Further, the method may include determining whether the second cell and the first cell are within a common cell broadcast area. Moreover, the method may include maintaining a message header associated with the first cell after the UE begins receiving service from the second cell upon a determination that the first cell and the second cell are within the common cell broadcast area.

Another aspect relates to a computer program product comprising a computer-readable medium. The computer program product may include a computer-readable medium including a first set of codes for causing a computer to detect selection of a second cell by a UE being served by a first cell. The computer program product may further include a computer-readable medium including a second set of codes for causing the computer to determine whether the second cell and the first cell are within a common cell broadcast area. The computer program product may still further include a computer-readable medium including a third set of codes for causing the computer to maintain a message header associated with the first cell after the UE begins receiving service from the second cell upon a determination that the first cell and the second cell are within the common cell broadcast area.

Yet another aspect relates to an apparatus. The apparatus may include means for detecting selection of a second cell by a UE being served by a first cell. The apparatus may further include means for determining whether the second cell and the first cell are within a common cell broadcast area. Moreover, the apparatus may include means for maintaining a message header associated with the first cell after the UE begins receiving service from the second cell upon a determination that the first cell and the second cell are within the common cell broadcast area.

Another aspect relates to an apparatus. The apparatus may include a CBS processing module configured to detect selection of a second cell by a UE being served by a first cell. Further, the CBS processing module may be configured to determine whether the second cell and the first cell are within a common cell broadcast area. Moreover, the CBS processing module may be configured to maintain a message header associated with the first cell after the UE begins receiving service from the second cell upon a determination that the first cell and the second cell are within the common cell broadcast area.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a block diagram of a communication network, according to an aspect;

FIG. 2 is another block diagram of a communication network, according to an aspect;

FIG. 3 is a block diagram of a cell broadcast service message structure;

FIG. 4 is a flowchart of an aspect of a communication network enabled to optimize a CBS message decoding process;

FIG. 5 is an example block diagram of a communications device, according to an aspect; and

FIG. 6 illustrates a block diagram of an example communications device that can optimize a CBS message decoding process.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

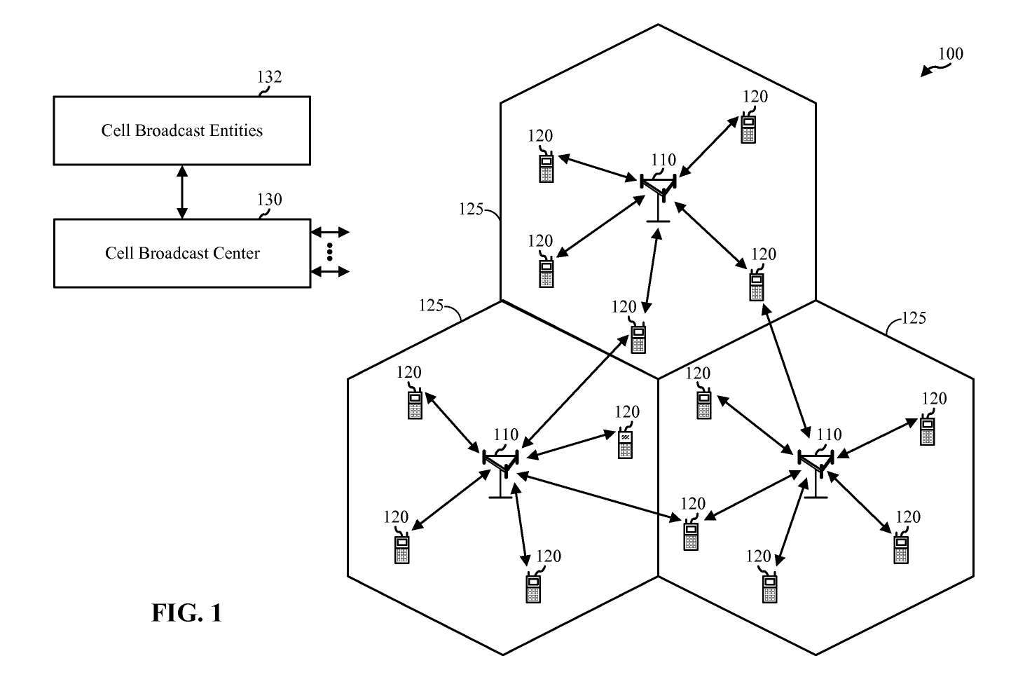

With reference to FIG. 1, a block diagram of a communication network 100 according to an aspect is illustrated. As illustrated, communication network 100 may include a number of base stations 110 that support communication for a number of UEs 120 within different cells 125. A base station 110 may be a fixed station used for communicating with the UEs 120 and can also be called an access point, a base transceiver station (BTS), a NodeB, an eNodeB or some other terminology. A UE 120 may be fixed or mobile and may also be referred to by those skilled in the art as a mobile equipment (ME), a mobile station (MS), a subscriber station, a mobile unit, a subscriber unit, a wireless unit, a subscriber unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other terminology. The UEs 120 may be dispersed throughout the system. Each base station 110 may communicate with any number of UEs 120 at any given moment depending on various factors such as, for example, the number of UEs 120 within the coverage (e.g., cell) of the base station 110, the available system resources, the data requirements of the UEs 120, and so on.

Cell broadcast Center (CBC) 130 may provide cell broadcast services to communication network 100. The Cell Broadcast Service (CBS) permits a number of unacknowledged general CBS messages to be broadcast to UEs 120 within a particular region. In an aspect, CBS messages may be broadcast to defined geographical areas known as cell broadcast areas. In such an aspect, the cell broadcast area may include of one or more cells 125, may include an entire public land mobile network (PLMN) (e.g., communication network 100), etc. In another aspect, CBS messages may be assigned their own geographical coverage areas by mutual agreement between an information provider and the PLMN operator.

CBC 130 may also communication with one or more cell broadcast entities 132. In an aspect, CBS messages may originate from these one or more cell broadcast entities 132 which may be connected to CBC 130.

In operation, CBC 130 may send CBS messages to the cells 125 in accordance with the CBS message coverage areas.

Accordingly, a communication network 100 is described in which a CBS is operable to provide CBS messages to one or more UEs 120.

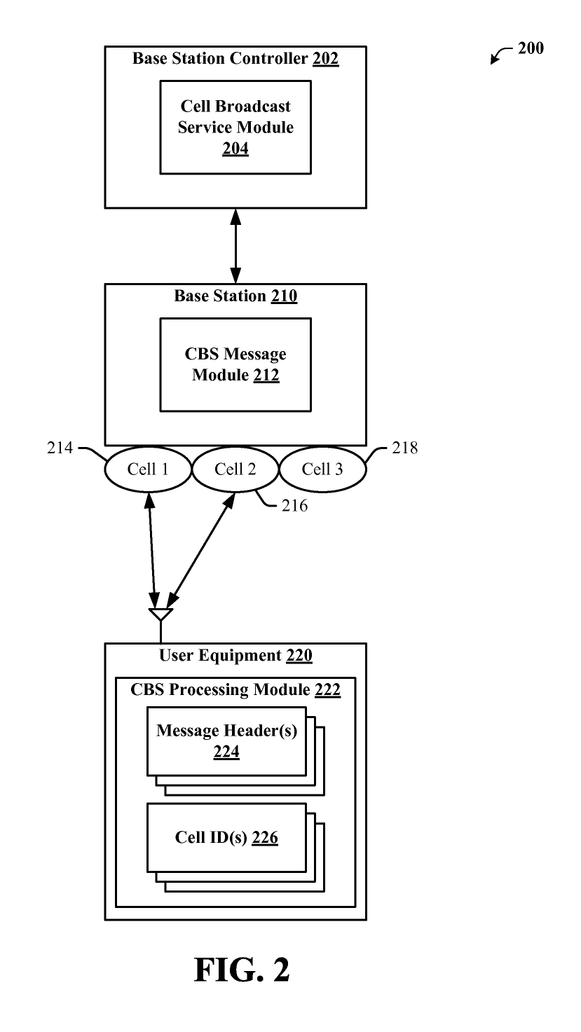

With reference to FIG. 2, a block diagram of an example communication network 200 is described. Communication network 200 may include a base station controller (BSC) 202, a base station 210 operable to communicate among one or more of a first cell 214, a second cell 216, and a third cell 218. In an aspect, a UE 220 may be in communication with base station 210 while receiving service through either first cell 214, or second cell 216.

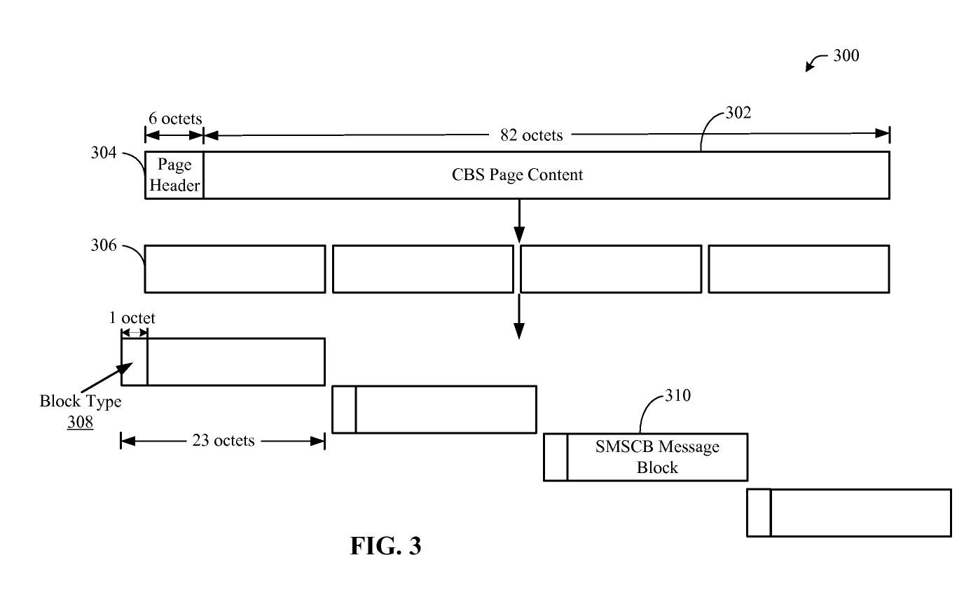

BSC 202 may be operable to provide CBS messages using cell broadcast service module 204. In an aspect, cell broadcast service module 204 may obtain one or more CBS messages from a CBC (e.g., CBC 130), and provide one or more CBS messages to base station 210. Base station 210 may include CBS message module 212 which may be operable to transmit a CBS message to UE 220. In an aspect, CBS messages transmitted by the base station 210 to UE 220 may include the information for a user and schedule information (e.g., schedule of CBS messages). Further description of the structure of a CBS message is provided with reference to FIG. 3.

UE 220 may include CBS processing module 222 which is operable to optimize a CBS message decoding process. In an aspect, CBS processing module 222 may be operable to optimize duplicate detection when UE 220 is in ping pong reselection between first cell 214, second cell 216, and/or more cells. CBS processing module 222 may be operable to prompt UE 220 to store unique message headers 224 with cell IDs 226. Table 1 provides an example format of information stored by UE 220.

TABLE 1
UE Stored Format of Decoded Message Headers with Cell IDs

| Cell ID | C1 | | | | | C2 | | | | | C3 | | | | |
|---|---|---|---|---|---|---|---|---|---|---|---|---|---|---|---|
| Geographical Scope | 0 | 0 | 0 | 0 | 0 | 0 | 0 | 0 | 0 | 0 | 0 | 0 | 0 | 0 | 0 |
| (GS) | | | | | | | | | | | | | | | |
| Message Code | 98 | 98 | 98 | 98 | 98 | 98 | 98 | 98 | 98 | 98 | 98 | 98 | 98 | 98 | 98 |
| Update Number | 0 | 0 | 0 | 0 | 0 | 0 | 0 | 0 | 0 | 0 | 0 | 0 | 0 | 0 | 0 |
| Message Identifier | 1 | 2 | 3 | 4 | 5 | 1 | 2 | 3 | 4 | 5 | 1 | 2 | 3 | 4 | 5 |
| Data Coding | F2 | F2 | F2 | F2 | F2 | F2 | F2 | F2 | F2 | F2 | F2 | F2 | F2 | F2 | F2 |
| Scheme | | | | | | | | | | | | | | | |
| Page Parameter | 11 | 11 | 11 | 11 | 11 | 11 | 11 | 11 | 11 | 11 | 11 | 11 | 11 | 11 | 11 |

Further, CBS processing module 222 may prompt the UE 220 to not erase the CBS message information (e.g., decoded message headers 224, cell IDs 226, etc.) until a change in cell broadcast area is detected. For example, where a cell broadcast area is cell wide, then any CBS message received in the next cell is regarded as new. In another example, where a cell broadcast area is PLMN wide, then a message code and/or update number change may indicate that in the next cell is regarded as new. In another example, where the cell broadcast area is location area wide (e.g., in a GSM based communication network), then a CBS message with the same Message Code and Update Number may or may not be “new” in the next cell according to whether the next cell is in the same Location Area as the current cell. In another example, where the cell broadcast area is service area wide (e.g., in a UMTS based communication network), then a CBS message with the same Message Code and Update Number may or may not be “new” in the next cell according to whether the next cell is in the same Service Area as the current cell.

Continuing the operational aspect, by storing message headers 224 and cell IDs 226, even if UE 220 is in ping pong reselection with more cells (214, 216, 218, etc.), the UE has all the decoded unique message headers 224 with respect to Cell IDs 226 and as such may efficiently perform duplicate detection. Further, UE 220 may avoid reception of same CBS messages and as such may reduce battery consumption. In an aspect, the UE 220 may display information associated with newly received of CBS message information. In such an aspect, the UE 220 may reduce duplicative displaying of CBS message information.

With reference to FIG. 3, a block diagram of an example CBS message structure 300 is described. In an aspect, a CBS message structure 300 may include to 15 CBS pages. Each CBS page may be a fixed block of 88 octets which may include 82 octets of CBS page content 302 and 6 octets of page header 304. In an aspect, page header 304 may be formatted according to Table 2.

TABLE 2
CBS Page Header

| Octet Number(s) | Field |
|---|---|
| 1-2 | Serial Number |
| 3-4 | Message Identifier |
| 5 | Data Coding Scheme |
| 6 | Page Parameter |

Further, each CBS page may be partitioned to four 22-octet blocks 306. A one octet Block type 308 may be added as a header to each 22-octet block 306 to result in a 23-octet block called a SMS Cell Broadcast (SMSCB) message block 310. In an aspect, block type 308 may be formatted according to Table 3.

TABLE 3
Block Type Content

| | | | | | | | | |
|---|---|---|---|---|---|---|---|---|
| 8 | 7 | 6 | 5 | 4 | 3 | 2 | 1 | Octet: |

| | | | | |
|---|---|---|---|---|
| Spare | LPD | LB | Sequence Number | 1 |

| | | |
|---|---|---|
| 0 | 0 | 1 |

In Table 3, the eighth bit of the block type 308 octet may be reserved as spare, the sevenths and sixths bits may be used for a link protocol discriminator (LPD), the fifth bit may be used for a last bit (LB), and the fourth through first bit may be used for a sequence number.

Further, in operation, the SMSCB message blocks 310 may be sent through CBC (e.g., 130) to the UEs (e.g., 120).

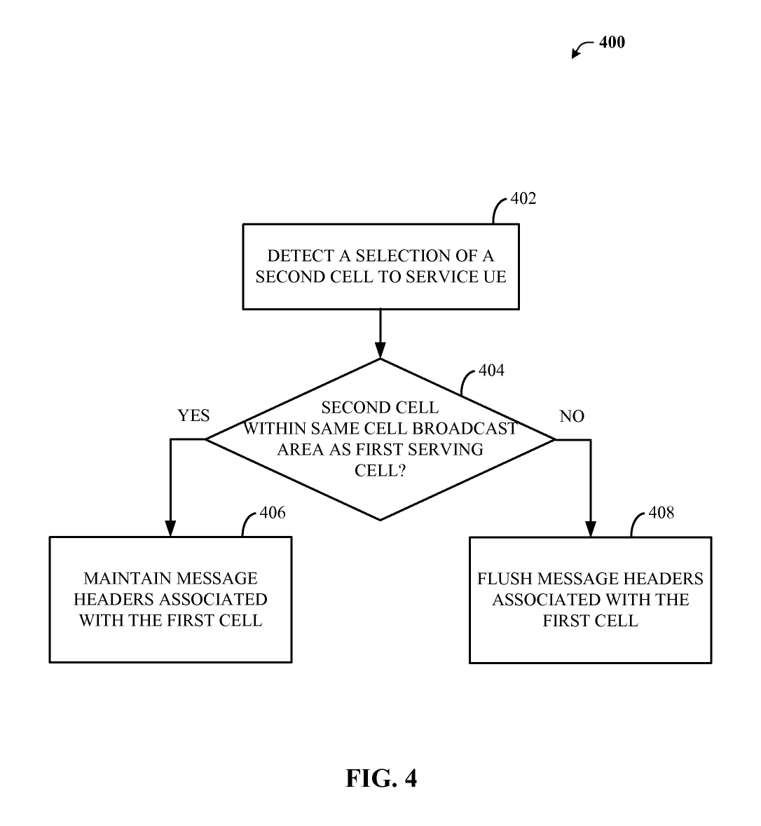

FIG. 4 illustrates various methodologies in accordance with the claimed subject matter. While, for purposes of simplicity of explanation, the methodologies are shown and described as a series of acts, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Referring to FIG. 4, a process 400 for a UE to perform efficient CBS message header retention is described.

At block 402, a UE may detect selection of a second cell to serve the UE that is currently being served by a first cell. In one aspect, the UE has stored CBS page header information associated with the first cell.

At block 404, the UE may determine whether the second cell is within a common cell broadcast area as the first cell. In one aspect, the cell broadcast area may be defined by a service provider. In another aspect, the cell broadcast area may be an entire PLMN wide defined area. In still another aspect, the cell broadcast area may be a cell wide area, a location area wide area, a service area wide area, etc.

If at block 404, the UE determines that the first cell and the second cell are within a common cell broadcast area, then at block 406, the UE may maintain the message header information associated with the first cell. In one aspect, the maintained information may be retrieved from storage if/when the UE reselects the first cell for service. Such retrieve reduces searching and decoding that may be performed by the UE upon entrance to a cell for which it does not have message header information. This reduction may result in improved efficiency and reduced power consumption by the UE. In one aspect, the message header information may include a CBS page header with a cell identifier and a geographical scope value.

By contrast, if at block 404, the UE determines that the first cell and the second cell are not within a common location area, then at block 408, the UE may flush the message header information associated with the first cell.

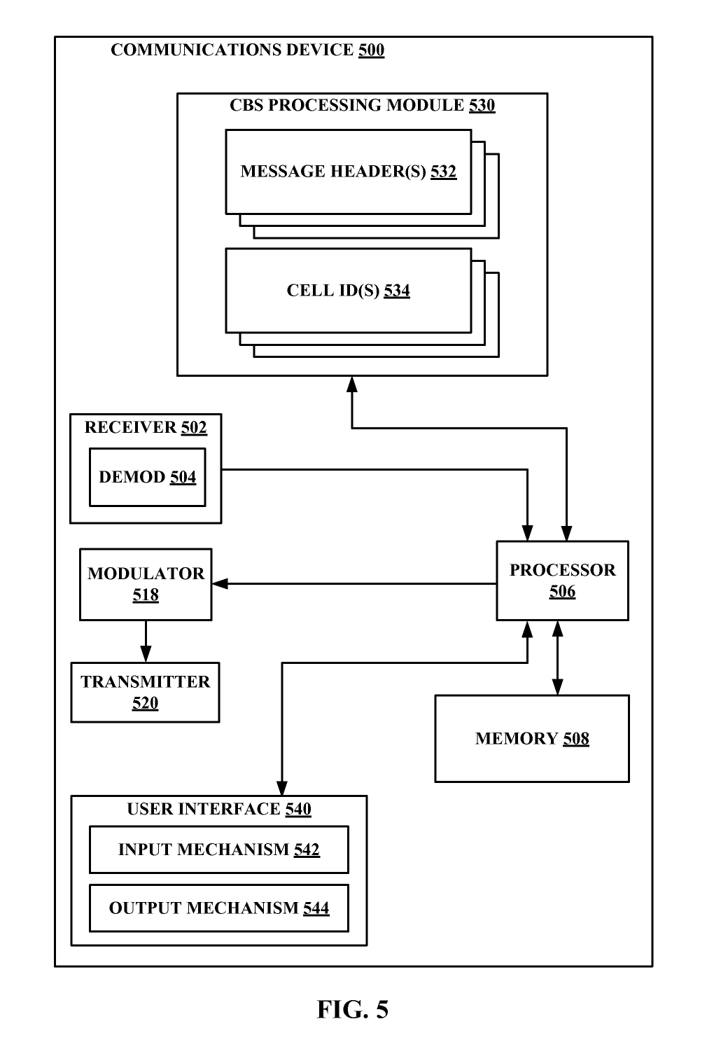

While referencing FIG. 2, but turning also now to FIG. 5, an example architecture of communications device 500 is illustrated. As depicted in FIG. 5, communications device 500 comprises receiver 502 that receives a signal from, for instance, a receive antenna (not shown), performs typical actions on (e.g., filters, amplifies, downconverts, etc.) the received signal, and digitizes the conditioned signal to obtain samples. Receiver 502 can include a demodulator 504 that can demodulate received symbols and provide them to processor 506 for channel estimation. Processor 506 can be a processor dedicated to analyzing information received by receiver 502 and/or generating information for transmission by transmitter 520, a processor that controls one or more components of communications device 500, and/or a processor 506 that analyzes information received by receiver 502, generates information for transmission by transmitter 520, and controls one or more components of communications device 500. Further, signals may be prepared for transmission by transmitter 520 through modulator 518 which may modulate the signals processed by processor 506.

Communications device 500 can additionally include memory 508 that is operatively coupled to processor 506 and that can store data to be transmitted, received data, information related to available channels, TCP flows, data associated with analyzed signal and/or interference strength, information related to an assigned channel, power, rate, CBS message information, or the like, and any other suitable information for estimating a channel and communicating via the channel.

Further, processor 506, receiver 502, transmitter 520, and/or CBS processing module 530 may be operable to perform CBS message processing and can provide means for detecting selection of a second cell by a communications device 500 being served by a first cell, means for determining whether the second cell and the first cell are within a common cell broadcast area, and means for maintaining a message header associated with the first cell after the UE begins receiving service from the second cell upon a determination that the first cell and the second cell are within the common cell broadcast area. In an aspect, the processor 506, receiver 502, transmitter 520, and/or CBS processing module 530 may also be operable provide means for flushing the message header associated with the first cell upon a determination that the first cell and the second cell are not within the common cell broadcast area.

It will be appreciated that data store (e.g., memory 508) described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Memory 508 of the subject systems and methods may comprise, without being limited to, these and any other suitable types of memory. In an aspect, memory 508 may be used to store information associated with CBS message headers. For example, memory may store geographical scope (GS) values (e.g., 532) associated with one or more previously used cells. In another aspect, the stored information may be flushed (e.g., deleted) upon a determination that the communications device 500 has moved to a new GS, upon a determination that the stored information has been stored for at least a threshold time duration (e.g., one minute, one hour, one day, etc.), upon a determination that the stored information has exceeded a threshold amount of storage space available for CBS message header storage in memory 508, etc.

Communications device 500 may include CBS processing module 530. In an aspect, CBS processing module 530 may further include one or more CBS message header values, such as but not limited to, message header values 532, cell identifiers 534, etc.

CBS processing module 530 may be operable to optimize a CBS message decoding process. In an aspect, CBS processing module 530 may be operable to optimize duplicate detection when communications device 500 is in ping pong reselection between various cells. CBS processing module 530 may be operable to prompt communications device 500 to store (e.g., in memory 508) unique message headers 532 with cell IDs 534. Further, CBS processing module 530 may prompt the communications device 500 to not erase the CBS message information (e.g., decoded message headers 532, cell IDs 534, etc.) until a change in cell broadcast area is detected.

Additionally, communications device 500 may include user interface 540. User interface 540 may include input mechanisms 542 for generating inputs into communications device 500, and output mechanism 544 for generating information for consumption by the user of the communications device 500. For example, input mechanism 542 may include a mechanism such as a key or keyboard, a mouse, a touch-screen display, a microphone, etc. Further, for example, output mechanism 544 may include a display, an audio speaker, a haptic feedback mechanism, a Personal Area Network (PAN) transceiver etc. In the illustrated aspects, the output mechanism 544 may include a display operable to present media content that is in image or video format or an audio speaker to present media content that is in an audio format. In an aspect, output mechanism 544 may be used to present CBS related information. In such an aspect, the CBS related information may indicate that the communications device 500 is experiencing a ping-pong situation (e.g., repeated switching amount a plurality of cells).

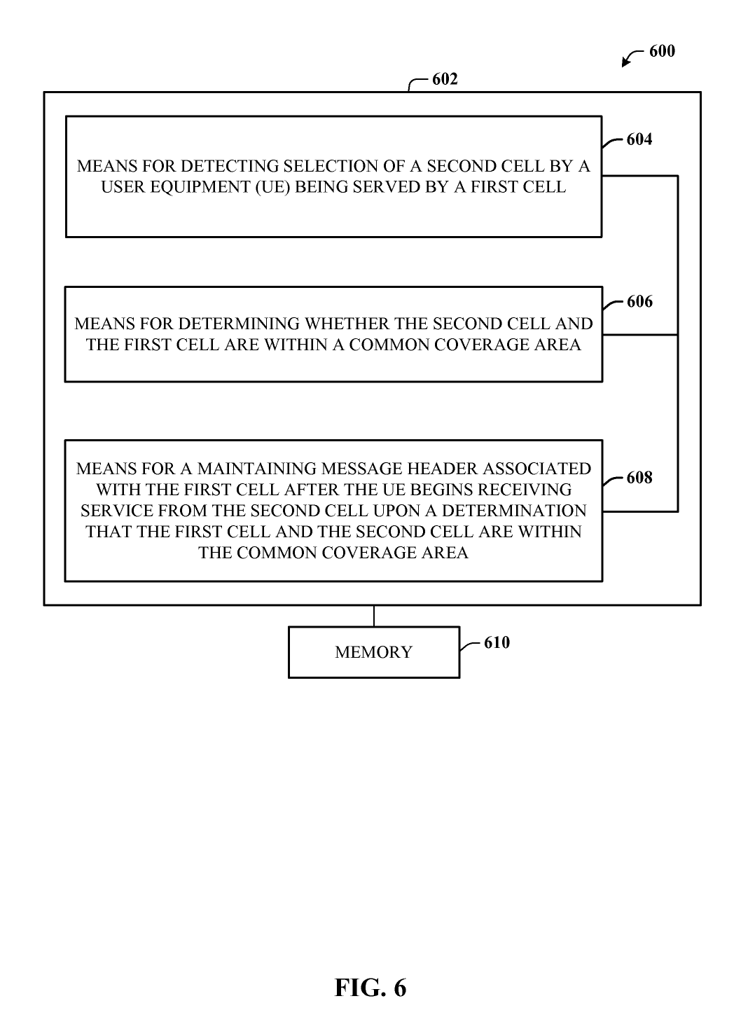

With reference to FIG. 6, a block diagram of an example system 600 that can optimize a CBS message decoding process is illustrated. For example, system 600 can reside at least partially within a wireless communications device, such as a UE, mobile station, etc. It is to be appreciated that system 600 is represented as including functional blocks, which can be functional blocks that represent functions implemented by a processor, software, or combination thereof (e.g., firmware).

System 600 includes a logical grouping 602 of means that can act in conjunction. For instance, logical grouping 602 can include means for detecting selection of a second cell by a UE being served by a first cell 604. In one aspect, means for detecting 604 may further include means for displaying information associated with selection of the second cell to a user of the UE. In another aspect, the means for detecting 604 may further include means for detecting reselection of the first cell by the UE, and means for retrieving a maintained message header associated with the first cell.

Further, logical grouping 602 can comprise means for determining whether the second cell and the first cell are within a common cell broadcast area 606. In one aspect, the cell broadcast area may be defined by a service provider. In another aspect, the cell broadcast area may be a cell wide area, a PLMN wide area, a location area wide area, a service area wide area, etc.

Further, logical grouping 602 can comprise means for maintaining a message header associated with the first cell after the UE begins receiving service from the second cell upon a determination that the first cell and the second cell are within the common cell broadcast area 608. In another aspect, the means for maintaining 608 may include means for flushing the message header associated with the first cell upon a determination that the first cell and the second cell are not within the common cell broadcast area. In another aspect, the means for maintaining 608 may further include means for storing the message header associated with the first cell in a memory associated with the UE. In such an aspect, the means for storing may further include means for storing a time stamp value with the stored message header, and means for flushing the stored message header upon an expiration of a threshold time duration based on continued serve from the second cell without the UE returning to being served by the first cell. In another, the means for maintaining 608 may further include means for determining that the stored message header uses at least a memory threshold amount of memory space in the memory associated with the UE, and means for flushing at least a portion of the stored message header. In one aspect, the message header may include a Cell Broadcast Service (CBS) message header including a cell identifier value and a geographical scope value.

Additionally, system 600 can include a memory 610 that retains instructions for executing functions associated with the electrical components 604, 606, and 608, stores data used or obtained by the electrical components 604, 606, 608, etc. While shown as being external to memory 610, it is to be understood that one or more of the electrical components 604, 606, and 608 may exist within memory 610. In an example, electrical components 604, 606, and 608 can include at least one processor, or each electrical component 604, 606, and 608 can be a corresponding module of at least one processor. Moreover, in an additional or alternative example, electrical components 604, 606, and 608 may be a computer program product including a computer readable medium, where each electrical component 604, 606, and 608 may be corresponding code.

An access point may be a fixed station used for communicating with the terminals and also may be referred to as an access point, a NodeB, a base station, or some other terminology. An access terminal may also be called an access terminal, user equipment (UE), a wireless communication device, terminal, access terminal or some other terminology.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal. A terminal can also be called a system, device, subscriber unit, subscriber station, mobile station, mobile, mobile device, remote station, mobile equipment (ME), remote terminal, access terminal, user terminal, terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with wireless terminal(s) and may also be referred to as an access point, a Node B, or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH, near-field communications (NFC-A, NFC-B, NFC-F, etc.), and any other short- or long-range, wireless communication techniques.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An example storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

In one or more aspects, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

While the foregoing disclosure discusses illustrative aspects and/or aspects, it should be noted that various changes and modifications could be made herein without departing from the scope of the described aspects and/or aspects as defined by the appended claims. Furthermore, although elements of the described aspects and/or aspects may be described or claimed in the singular, the plural is contemplated unless limitation to the singular is explicitly stated. Additionally, all or a portion of any aspect and/or aspect may be utilized with all or a portion of any other aspect and/or aspect, unless stated otherwise.

What is claimed is:

1. A method of wireless communications, comprising:
detecting selection of a second cell by a user equipment (UE) being served by a first cell;
determining whether the second cell and the first cell are within a common cell broadcast area; and
maintaining a message header associated with the first cell after the UE begins receiving service from the second cell upon a determination that the first cell and the second cell are within the common cell broadcast area.

2. The method of claim 1, further comprising:
detecting reselection of the first cell by the UE; and
retrieving the maintained message header associated with the first cell.

3. The method of claim 1, further comprising:
flushing the message header associated with the first cell upon a determination that the first cell and the second cell are not within the common cell broadcast area.

4. The method of claim 3, further comprising:
displaying information associated with selection of the second cell to a user of the UE.

5. The method of claim 1, wherein the message header comprises a Cell Broadcast Service (CBS) message header including a cell identifier value and a geographical scope value.

6. The method of claim 1, wherein the cell broadcast area is defined by a service provider.

7. The method of claim 1, wherein the cell broadcast area is one of a cell wide area, a public land mobile network (PLMN) wide area, a location area wide area, or a service area wide area.

8. The method of claim 1, wherein the maintaining further comprises:
storing the message header associated with the first cell in a memory associated with the UE.

9. The method of claim 8, wherein the storing further comprises:
storing a time stamp value with the stored message header; and
flushing the stored message header upon an expiration of a threshold time duration based on continued serve from the second cell without the UE returning to being served by the first cell.

10. The method of claim 1, wherein the maintaining further comprises:
determining that the stored message header uses at least a memory threshold amount of memory space in the memory associated with the UE; and
flushing at least a portion of the stored message header.

11. A computer program product, comprising:
a computer-readable medium comprising code for:
detecting selection of a second cell by a user equipment (UE) being served by a first cell;
determining whether the second cell and the first cell are within a common cell broadcast area; and
maintaining a message header associated with the first cell after the UE begins receiving service from the second cell upon a determination that the first cell and the second cell are within the common cell broadcast area.

12. The computer program product of claim 11, wherein the computer-readable medium further comprises code for:
detecting reselection of the first cell by the UE; and
retrieving the maintained message header associated with the first cell.

13. The computer program product of claim 11, wherein the computer-readable medium further comprises code for:
flushing the message header associated with the first cell upon a determination that the first cell and the second cell are not within the common cell broadcast area.

14. The computer program product of claim 13, wherein the computer-readable medium further comprises code for:
displaying information associated with selection of the second cell to a user of the UE.

15. The computer program product of claim 11, wherein the message header comprises a Cell Broadcast Service (CBS) message header including a cell identifier value and a geographical scope value.

16. The computer program product of claim 11, wherein the cell broadcast area is defined by a service provider.

17. The computer program product of claim 11, wherein the cell broadcast area is one of a cell wide area, a public land mobile network (PLMN) wide area, a location area wide area, or a service area wide area.

18. The computer program product of claim 11, wherein the computer-readable medium further comprises code for:
storing the message header associated with the first cell in a memory associated with the UE.

19. The computer program product of claim 18, wherein the computer-readable medium further comprises code for:
storing a time stamp value with the stored message header; and
flushing the stored message header upon an expiration of a threshold time duration based on continued serve from the second cell without the UE returning to being served by the first cell.

20. The computer program product of claim 11, wherein the computer-readable medium further comprises code for:
determining that the stored message header uses at least a memory threshold amount of memory space in the memory associated with the UE; and
flushing at least a portion of the stored message header.

21. An apparatus for wireless communications, comprising:
means for detecting selection of a second cell by a user equipment (UE) being served by a first cell;
means for determining whether the second cell and the first cell are within a common cell broadcast area; and
means for maintaining a message header associated with the first cell after the UE begins receiving service from the second cell upon a determination that the first cell and the second cell are within the common cell broadcast area.

22. The apparatus of claim 21, further comprising:
means for detecting reselection of the first cell by the UE; and
means for retrieving the maintained message header associated with the first cell.

23. The apparatus of claim 21, further comprising:
means for flushing the message header associated with the first cell upon a determination that the first cell and the second cell are not within the common cell broadcast area.

24. The apparatus of claim 23, further comprising:
means for displaying information associated with selection of the second cell to a user of the UE.

25. The apparatus of claim 21, wherein the message header comprises a Cell Broadcast Service (CBS) message header including a cell identifier value and a geographical scope value.

26. The apparatus of claim 21, wherein the cell broadcast area is defined by a service provider.

27. The apparatus of claim 21, wherein the cell broadcast area is one of a cell wide area, a public land mobile network (PLMN) wide area, a location area wide area, or a service area wide area.

28. The apparatus of claim 21, wherein the means for maintaining further comprises:
means for storing the message header associated with the first cell in a memory associated with the UE.

29. The apparatus of claim 28, wherein the means for storing further comprises:
means for storing a time stamp value with the stored message header; and
means for flushing the stored message header upon an expiration of a threshold time duration based on continued serve from the second cell without the UE returning to being served by the first cell.

30. The apparatus of claim 21, wherein the means for maintaining further comprises:
means for determining that the stored message header uses at least a memory threshold amount of memory space in the memory associated with the UE; and
means for flushing at least a portion of the stored message header.

31. An apparatus for wireless communications, comprising:
a cell broadcast service (CBS) processing module configured to:
detect selection of a second cell by a user equipment (UE) being served by a first cell;
determine whether the second cell and the first cell are within a common cell broadcast area; and
maintain a message header associated with the first cell after the UE begins receiving service from the second cell upon a determination that the first cell and the second cell are within the common cell broadcast area.

32. The apparatus of claim 31, wherein the CBS processing module is further configured to:
detect reselection of the first cell by the UE; and
retrieve the maintained message header associated with the first cell.

33. The apparatus of claim 31, wherein the CBS processing module is further configured to:
flush the message header associated with the first cell upon a determination that the first cell and the second cell are not within the common cell broadcast area.

34. The apparatus of claim 33, wherein the CBS processing module is further configured to:
display information associated with selection of the second cell to a user of the UE.

35. The apparatus of claim 31, wherein the message header comprises a Cell Broadcast Service (CBS) message header including a cell identifier value and a geographical scope value.

36. The apparatus of claim 31, wherein the cell broadcast area is defined by a service provider.

37. The apparatus of claim 31, wherein the cell broadcast area is one of a cell wide area, a public land mobile network (PLMN) wide area, a location area wide area, or a service area wide area.

38. The apparatus of claim 31, wherein the CBS processing module is further configured to:
store the message header associated with the first cell in a memory associated with the UE.

39. The apparatus of claim 38, wherein the CBS processing module is further configured to:
store a time stamp value with the stored message header; and
flush the stored message header upon an expiration of a threshold time duration based on continued serve from the second cell without the UE returning to being served by the first cell.

40. The apparatus of claim 31, wherein the CBS processing module is further configured to:
determine that the stored message header uses at least a memory threshold amount of memory space in the memory associated with the UE; and
flush at least a portion of the stored message header.
